(19) United States
(12) Patent Application Publication
(10) Pub. No.: US 2008/0277047 A1
(43) Pub. Date: Nov. 13, 2008

(54) FRP HONEYCOMB STRUCTURE AND METHOD FOR MANUFACTURING THE SAME

(75) Inventors: Yasuhiko KUBOTA, Kyoto (JP); Makoto HAYASHI, Kyoto-shi (JP); Eiki TSUSHIMA, Shizuoka (JP); Noriyasu TORIYAMA, Shizuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: MURATA KIKAI KABUSHIKI KAISHA, Kyoto (JP); FJ COMPOSITE MATERIALS CO., LTD., Shizuoka (JP); UNI TECH RESIN, INC., Shizuoka (JP)

(21) Appl. No.: 12/174,032

(22) Filed: Jul. 16, 2008

Related U.S. Application Data
(62) Division of application No. 11/476,780, filed on Jun. 29, 2006.

(51) Int. Cl. B32B 3/12; D04C 1/02

(52) U.S. Cl. 156/148

(57) ABSTRACT

The present invention provides an FRP honeycomb structure which is used as a base structure material for various base structures and which offers appropriate rigidity and compression strength while reducing the weight of the entire structure. The present invention provides an FRP honeycomb structure HA formed by assembling together a plurality of FRP core units CU having the same cross sectional shape so that outer sides of the units are abutted against one another, and hardening the assembled FRP core units CU using a resin material, as well as a method for manufacturing an FRP honeycomb structure HA, the method comprising a core unit forming step of constructing an FRP braid layer 2, 3 around a core member (mandrel) m having a polygonal cross section, impregnating the FRP braid layer 2, 3 with a resin material, and hardening the FRP braid layer to form each FRP core unit CU, and a honeycomb structure forming step of assembling the FRP core units CU together so that outer sides of the FRP core units CU are abutted against one another, impregnating the assembled FRP core units CU with a resin material, and then hardening the resulting FRP core units CU to form an FRP honeycomb structure HA.

This application is a division of application Ser. No. 11/476,780, filed Jun. 29, 2006.

### FIELD OF THE INVENTION

The present invention relates to a honeycomb structure made of fiber reinforced plastics (hereinafter referred to as FRP) formed by braiding a fiber material for FRP such as carbon fibers.

### BACKGROUND OF THE INVENTION

As is well-known, honeycomb structures are utilized to allow composite materials to be used for certain applications; the honeycomb structures offer appropriate rigidity and compression strength while reducing the weight of the entire structure. As a conventional honeycomb structure, an FRP plate having a sandwich structure is known as disclosed in the Unexamined Japanese Patent Application Publication (Tokkai-Hei) No. 2000-52459 (Abstract and FIGS. 1 to 3).

The FRP in such a structure is a composite material formed by hardening a fiber material such as carbon fiber or glass fiber using a matrix of various plastics. An FRP composite structure material having a reduced weight and an increased strength has thus been developed and used in many industrial fields. This FRP material is made up by setting a fiber material such as carbon fiber or glass fiber in a braider, which then executes a braiding process to form an FRP material of plural layers around a mandrel. To form a preform using the FRP material composed of the plural layers, the FRP material is impregnated with a resin material or the resin material is attached to the FRP material. The FRP material is then heated under pressure and thus hardened. Subsequently, the mandrel is pulled out to obtain a completed structure.

In an FRP honeycomb structure in a conventional example, as shown in FIGS. 1 and 2 in the Unexamined Japanese Patent Application Publication (Tokkai-Hei) No. 2000-52459, a material sheet 9 made of FRP is introduced into a corrugate forming device 10 comprising a gear 12 and a rack 13 to form a corrugated plate 11, and corrugated plates 11 and flat plates 14 are superimposed on one another to obtain a honeycomb structure.

The method for manufacturing a honeycomb structure by superimposing junction presents many problems: the design height T of the honeycomb structure determined by the width of the material sheet 9 is limited, the uniform material of the core precludes the optimum in-plane design, and honeycomb cores cannot have diverse core sections; many of the honeycomb cores have a hexagonal cross section.

It is thus an object of the present invention to provide an FRP honeycomb structure which is used as a base structure material for various base structures and which offers appropriate rigidity and compression strength while reducing the weight of the entire structure, and in particular, to provide an FRP honeycomb structure which is not limited in a height direction T and which allows core units of different components to be selectively combined together in its cross section in order to adjust to diverse designs, as well as a method for manufacturing the FRP honeycomb structure.

### SUMMARY OF THE INVENTION

To accomplish the above object, specifically, the present invention provides an FRP honeycomb structure characterized by being formed by assembling together a plurality of FRP core units having the same cross sectional shape so that outer sides of the FRP core units are abutted against one another, and hardening the assembled FRP core units using a resin material.

An aspect of the present invention set forth in Claim 2 is the FRP honeycomb structure according to Claim 1, characterized in that the FRP core units include different components, and in that the outer sides of the FRP core units are abutted against one another, and the assembled FRP core units are hardened using the resin material to form a hybrid structure in a cross section.

An aspect of the present invention set forth in Claim 3 is the FRP honeycomb structure according to Claim 1 or Claim 2, characterized in that each of the FRP core units has a cross section shaped like a polygon such as a triangle, a rectangle, a hexagon, or an octagon.

An aspect of the present invention set forth in Claim 4 provides a method for manufacturing an FRP honeycomb structure, the method being characterized by comprising a core unit forming step of constructing an FRP braid layer (FRP material) around a core member (mandrel) having a polygonal cross section, impregnating the FRP braid layer with a resin material and hardening the FRP braid layer to form each FRP core unit, and a honeycomb structure forming step of assembling the FRP core units together so that outer sides of the FRP core units are abutted against one another, impregnating the assembled FRP core units with a resin material and then hardening the resulting FRP core units to form an FRP honeycomb structure.

An aspect of the present invention set forth in Claim 5 is the method for manufacturing an FRP honeycomb structure according to Claim 4, the method being characterized in that the core member has a cross section shaped like a polygon such as a triangle, a rectangle, a hexagon, or an octagon.

An aspect of the present invention set forth in Claim 6 is the method for manufacturing an FRP honeycomb structure according to Claim 4 or Claim 5, the method being characterized in that the core unit forming step comprises selectively combining a braid yarn with a braid angle of ±θ° and a middle yarn with a braid angle of 0°, and using a braider to make up a braid layer on a mandrel serving as a core member.

An aspect of the present invention set forth in Claim 7 is the method for manufacturing an FRP honeycomb structure according to Claim 4 or Claim 5, the method being characterized in that the core unit forming step comprises winding a sheet-like fiber unidirectional material (UD sheet) or cloth material around the core member, impregnating the fiber unidirectional material or cloth material with a resin material, and then hardening the resulting fiber unidirectional material or cloth material.

An aspect of the present invention set forth in Claim 8 is the method for manufacturing an FRP honeycomb structure according to Claim 4 or Claim 5, the method being characterized in that the core unit forming step comprises slitting a sheet-like fiber unidirectional material (UD sheet) or cloth material to a desired width to form band-like members, superimposing the band-like members on the outer sides of the core member, impregnating the superimposed band-like members with a resin material, and hardening the resulting band-like members.

An aspect of the present invention set forth in Claim 9 is the method for manufacturing an FRP honeycomb structure according to any one of Claims 4 to 8, the method being characterized in that the FRP honeycomb structure is formed by preparing plural types of FRP core units having different braiding yarn types, yarn amounts, yarn thicknesses, braid layer constructions, resin types, or resin amounts, assembling the FRP core units together, and subjecting the FRP core units to a resin material process.

An aspect of the present invention set forth in Claim 10 is the method for manufacturing an FRP honeycomb structure according to any one of Claims 4 to 9, the method being characterized in that the honeycomb structure forming step includes a step of coupling together FRP honeycomb structures formed by assembling the FRP core units together so that sides of the FRP honeycomb structures are abutted against one another, to form an FRP honeycomb composite.

The FRP honeycomb structure according to the present invention is obtained by pre-forming a plurality of FRP core units having the same cross sectional shape, assembling these FRP core units together so that their sides are abutted against one another, hardening the assembled FRP core units using a resin material.

The present invention very effectively eliminates the design limit on the height T of the FRP honeycomb structure, thus enabling a large FRP honeycomb structure with the height T to be provided.

In the FRP honeycomb structure according to the present invention, the FRP core units are composed of FRP materials including different components. The FRP core units are assembled together so that their outer sides are abutted against one another, and the assembled FRP core units are hardened using a resin material, to obtain the FRP honeycomb structure. The present invention thus very effectively provides a hybrid structure in the cross section of the FRP honeycomb structure.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic perspective view illustrating the basic configuration of a braiding composition base material obtained by a braiding process.

FIG. 2 is a schematic perspective view showing the basic configuration of an FRP honeycomb structure HA according to the present invention.

FIG. 3 illustrates a process of manufacturing an FRP honeycomb structure HA according to the present invention; FIG. 3A is a schematic perspective view showing an example of an FRP core unit, and FIG. 3B is a schematic perspective view of an FRP honeycomb structure formed by assembling n FRP core units together.

FIG. 4 is a schematic perspective view of a honeycomb composite formed by assembling N FRP honeycomb structures together.

FIG. 5 is a flowchart showing a procedure of forming an FRP core unit and a procedure of assembling FRP core units together to form an FRP honeycomb structure, in order of steps.

FIG. 6 is a schematic front view showing an example of basic configuration of a braider.

FIG. 7 is a cross sectional view of the braider shown in FIG. 6.

### DETAILED DESCRIPTION OF THE PREFERRED EMBODIMENTS

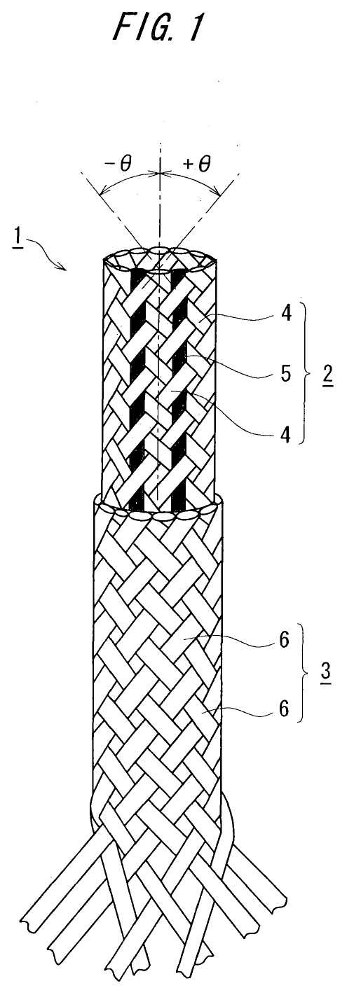

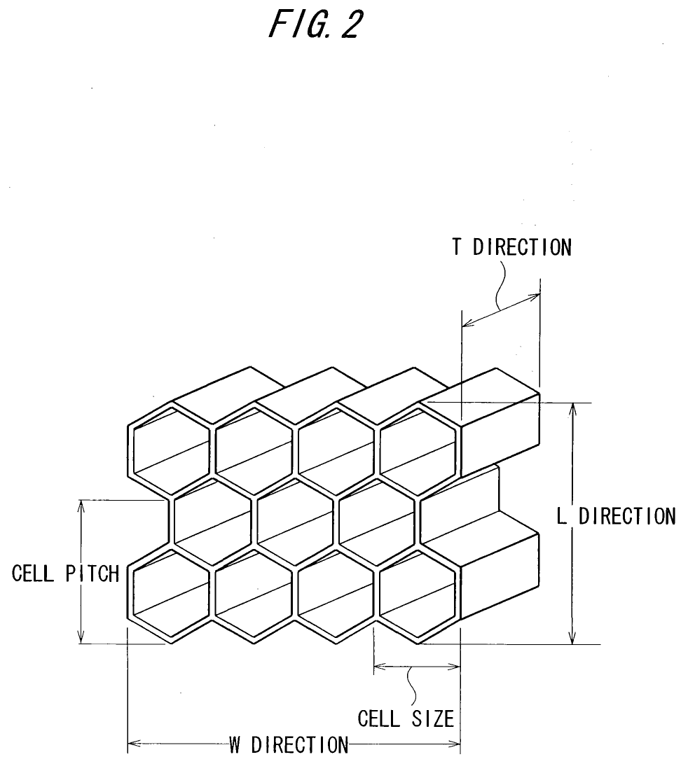

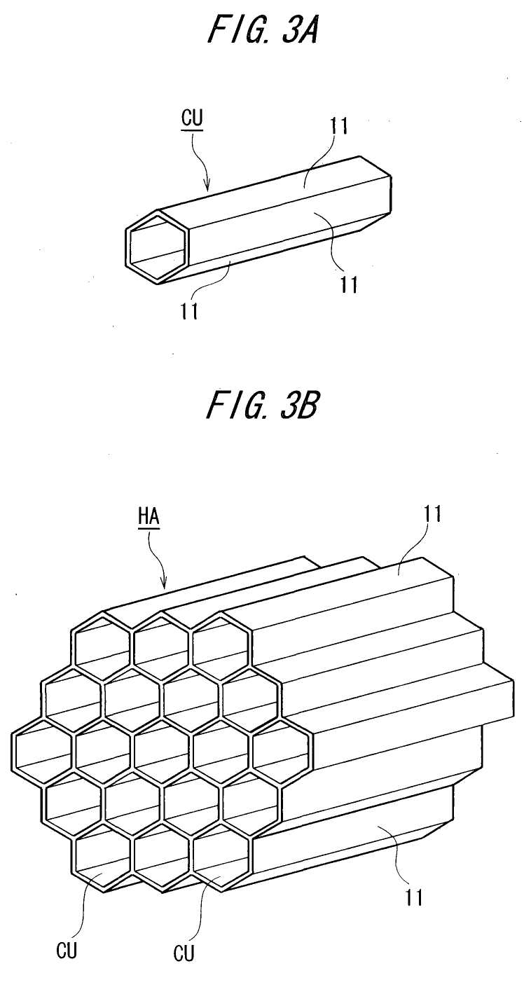

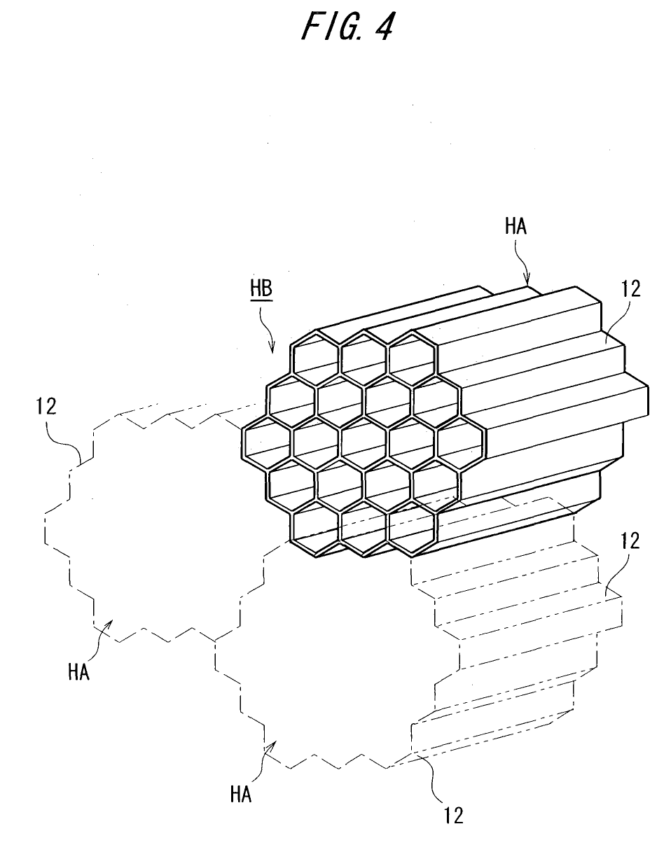

On the basis of a specific embodiment shown in the drawings, a detailed description will be given of an FRP honeycomb structure and a method for manufacturing an FRP honeycomb structure according to the present invention. FIG. 1 is a schematic perspective view illustrating the basic configuration of a braiding composition base material (FRP material) obtained by a braiding process. FIG. 2 is a schematic perspective view showing the basic configuration of an FRP honeycomb structure according to the present invention. FIG. 3 illustrates a process of manufacturing an FRP honeycomb structure according to the present invention. FIG. 3A is a schematic perspective view showing an example of an FRP core unit. FIG. 3B is a schematic perspective view of an FRP honeycomb structure formed by assembling n FRP core units together. FIG. 4 is a schematic perspective view of a honeycomb composite formed by assembling N FRP honeycomb structures together.

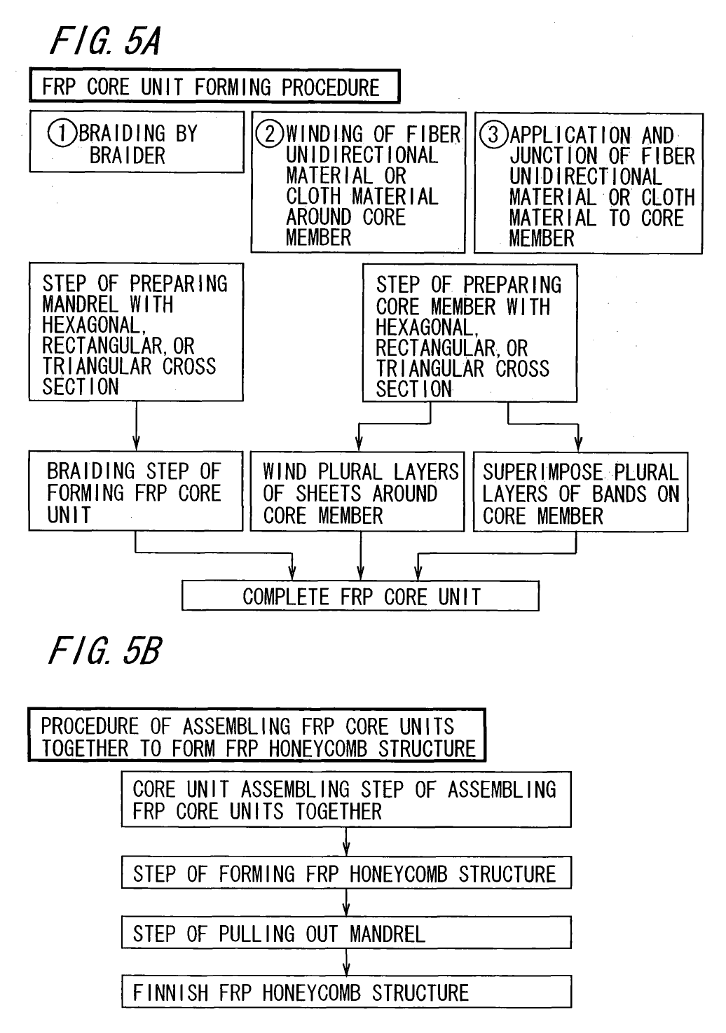

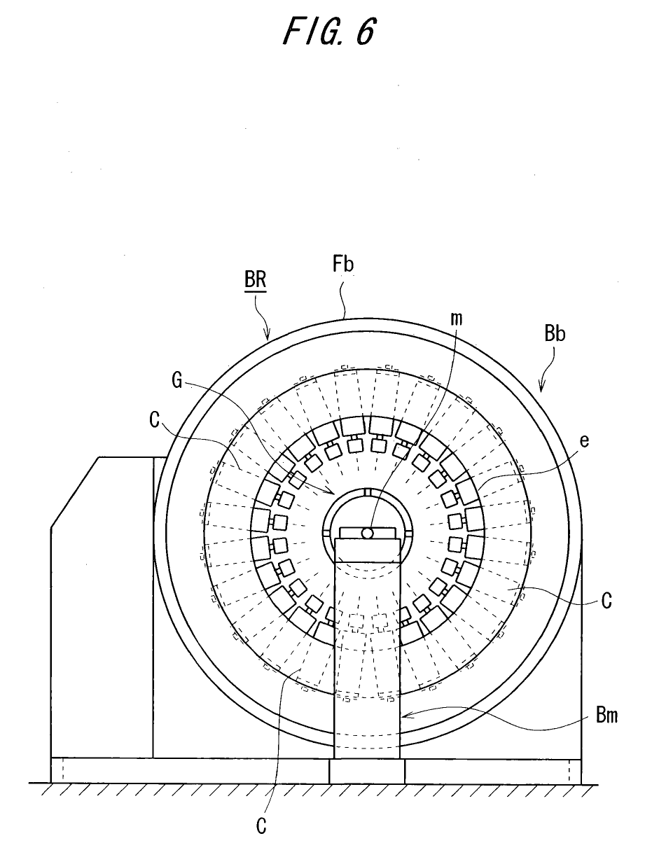

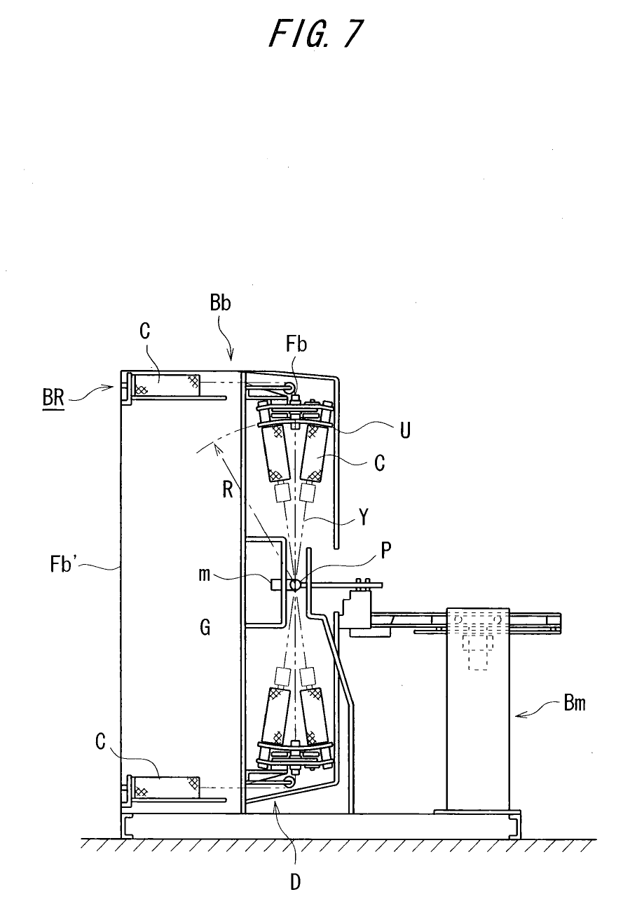

FIG. 5 is a flowchart showing a procedure of forming an FRP core unit and a procedure of assembling FRP core units together to form an FRP honeycomb structure, in order of steps. FIG. 6 is a schematic front view showing an example of basic configuration of a braider. FIG. 7 is a cross sectional view of the braider shown in FIG. 6.

In constructing a structure for various basic structures, the present invention provides an FRP honeycomb structure that is a basic structure material offering appropriate rigidity and compression strength while reducing the weight of the entire structure. To achieve this, the present invention applies a braiding technique to manufacture of the FRP honeycomb structure. With the braiding technique, such a braider as shown in FIGS. 6 and 7 is used to make a braiding composition base material (FRP material) such as the one shown in FIG. 1. For example, carbon fibers or the like are used, and a pair of braid yarns Y, Y (4, 4) with a braid angle of ±θ° to the axis of a mandrel (core member) (m) (braid angle is 0°<θ°<90°), and a middle yarn y (5) with a braid angle of 0° to the axis of the mandrel (m) are set in the braider. Braiding is carried out to make up a tube-like FRP material around the mandrel (m).

An example of configuration of a braider will be described with reference to FIGS. 6 and 7. In FIGS. 6 and 7, a braider BR is composed of a braider main body Bb and a mandrel device Bm.

The braider main body Bb in the braider BR has a curved upper plate U with a radius of curvature R which is placed in a cylindrical machine frame Fb having a horizontal axis and an opening (e) on one side, and a bobbin carrier C that runs along a track formed in the upper plate U in a circumferential direction, a driving device D that runs the bobbin carrier C along the track, and a yarn guiding device G.

Yarns Y drawn out from bobbins placed on the bobbin carrier C, in an axial direction of the bobbins, gather almost at the center of the upper plate U, and the position of the mandrel (m) attached to the mandrel device Bm is such that a braiding point P of a braid formed on the mandrel (m) is positioned at the center of the upper plate U. The mandrel device Bm can perform one-, two-, or three-dimensional positional control.

Thus, the bobbin carrier C is run along the track by the driving device D, and the position of the mandrel (m) is controlled by the mandrel device Bm. As a result, a large number of yarns Y intertwine with one another. As required, a middle yarn (y) is drawn out from the bobbin carrier C, which is placed almost horizontally to a frame Fb′ of the machine frame Fb, and the middle yarn (y) intertwines with the yarns Y which are drawn out from the bobbin carriers C running along the track and are braided. Braiding is thus carried out to braid a braid layer on the mandrel (m) with any of various shapes. The present invention enables plural laminated braid layers to be formed.

Now, on the basis of an example of a basic configuration shown in FIG. 1, a description will be given of the compositional structure of an FRP material on which the FRP honeycomb structure according to the present invention is based. A laminated structure 1 of the FRP material shown in FIG. 1 is a typical example in which a cylindrical (pipe-like) FRP material is made up of an inner braid layer 2 and an outer braid layer 3. The braid layer may be a single layer or may be made up of plural laminated layers.

In the example shown in FIG. 1, the inner braid layer 2 is formed of braid yarns 4, 4 with a braid angle of ±θ° to the axis of the FRP material and a middle yarn 5 with a braid angle of 0° to the axis to the FRP material, and forms the braid layer having a layer structure with a large elastic modulus in the axial direction. On the other hand, the outer braid layer 3 is formed only of braid yarns 6, 6 with a braid angle of ±θ° to the axis of the FRP material an d has no middle yarn 5 with a braid angle of 0° to the axis of the FRP material, and forms the braid layer with a layer structure having a small elastic modulus in the axial direction and being subject to large breaking strain.

Now, on the basis of a specific embodiment shown in FIGS. 2 to 5, a detailed description will be given of the basis configuration of the FRP honeycomb structure and a method for manufacturing an FRP honeycomb structure according to the present invention. The method for manufacturing an FRP honeycomb structure according to the present invention basically involves a core unit forming step of constructing an FRP braid layer (FRP material) around a core member (mandrel) having a polygonal cross section, impregnating the FRP braid layer with a resin member, and hardening the resulting FRP braid layer to form each FRP core unit CU, and a honeycomb structure forming step of assembling the FRP core units CU together so that their sides are abutted against one another, impregnating the assembled FRP core units with a resin material, and hardening the resulting FRP core units CU to form a honeycomb structure HA.

First, according to the present invention, the FRP core unit CU, shown in FIG. 3A, is manufactured and prepared in accordance with a core unit forming procedure shown in FIG. 5A. According to the present invention, examples of the method for forming the FRP core unit CU include \textcircled{1} the use of a braider, \textcircled{2} winding of a fiber unidirectional material (UD sheet) or cloth material around a core member, and \textcircled{3} application and junction of bands into which a fiber unidirectional material (UD sheet) or cloth material is formed.

\textcircled{1} Where a braider is used to form an FRP core unit CU, the mandrel (m) with a hexagonal cross section is prepared and set in the braider. Braid yarns with a braid angle of ±θ° and a middle yarn with a braid angle of 0° are selectively combined together to form a braid layer (FRP material), which is then impregnated with a resin material. The resulting braid layer is hardened to form an FRP core unit CU.

\textcircled{2} Where a fiber unidirectional material or cloth material is wound around a core member to form an FRP core unit CU, for example, a braiding sheet is prepared by cutting open a cylindrical braiding material made up by a braider, along a generating line. The braiding sheet is then wound around a core member with a hexagonal cross section and then impregnated with resin. The resulting braiding sheet is hardened to form an FRP core unit CU.
\textcircled{3} Where bands into which a fiber unidirectional material or cloth material is formed are applied and joined to a core member, for example, a braiding sheet is obtained by cutting open a cylindrical braiding material made up by a braider, along a generating line. The braiding sheet is slit to a desired width to form braiding bands, which are then applied and joined to outer sides of a core member along the axial direction. The braiding bands are impregnated with resin and then hardened to form an FRP core unit CU.

Any of these methods is used to make up, form, and prepare an FRP core unit CU. Plural types of FRP core units CU can be prepared which have different mechanical and physical characteristics depending on braiding yarn type, yarn amount, yarn thickness, braid layer construction, resin type, and resin amount.

According to the present invention, FRP core units CU formed as described above are assembled together so that their outer sides 11 are abutted against one another. The FRP core units CU are impregnated with a resin material and then hardened to form an FRP honeycomb structure HA. In this case, when the FRP core units CU include different components, the honeycomb structure HA has a hybrid structure in its cross section.

As shown in FIG. 3B, the present invention also makes it possible to form an FRP honeycomb composite HB by assembling n (in the embodiment schematically shown in FIG. 3B, 19) FRP core units CU together to form each FRP honeycomb structure HA, preparing and coupling N (in the embodiment schematically shown in FIG. 4, three) FRP honeycomb structures HA together so that their outer sides 12 are abutted against one another, impregnating the FRP honeycomb structures HA with a resin material, and hardening the resulting FRP honeycomb structures HA. The FRP honeycomb composite HB thus formed has an advanced hybrid structure in its cross section.

According to the present invention, where n FRP core units CU are assembled together and subjected to a resin process to form an FRP honeycomb structure HA or where N FRP honeycomb structures HA are assembled together and subjected to a resin process to form an FRP honeycomb composite HB, the FRP honeycomb structure HA can be reliably formed by executing a heating, pressurizing, and sucking processes with a core member remaining set in each FRP core unit CU.

According to the present invention, the FRP honeycomb structure HA or FRP honeycomb composite HB formed as described above is finished through a core member pull-out step of pulling out the core member.

The present invention eliminates the design limit on the height of the FRP honeycomb structure HA, thus enabling an FRP honeycomb structure HA with a large height T to be provided. Further, the FRP core units CU are composed of braids including different components, thus providing an FRP honeycomb structure HA having an advanced hybrid structure in its cross section.

The FRP honeycomb structure HA or FRP honeycomb composite HB configured as described above can constitute a precision surface plate, a robot hand, a floor material for airplanes, and a body material for automobiles. The FRP honeycomb structure HA can also be three-dimensionally processed to construct a three-dimensional structure such as a golf club head.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

1. A method for manufacturing an FRP honeycomb structure, the method being characterized by comprising a core unit forming step of constructing an FRP braid layer around a core member having a polygonal cross section, impregnating the FRP braid layer with a resin material, and hardening the FRP braid layer to form each FRP core unit, and a honeycomb structure forming step of assembling the FRP core units together so that outer sides of the FRP core units are abutted against one another, impregnating the assembled FRP core units with a resin material, and then hardening the resulting FRP core units to form an FRP honeycomb structure.

2. A method for manufacturing an FRP honeycomb structure according to claim 1, the method being characterized in that the core member has a cross section shaped like a polygon such as a triangle, a rectangle, a hexagon, or an octagon.

3. A method for manufacturing an FRP honeycomb structure according to claim 1 or claim 2, the method being characterized in that the FRP core unit forming step comprises selectively combining a braid yarn with a braid angle of ±θ° and a middle yarn with a braid angle of 0° and using a braider to make up a braid layer on a mandrel serving as a core member.

4. A method for manufacturing an FRP honeycomb structure according to claim 1 or claim 2, the method being characterized in that the core unit forming step comprises winding a sheet-like fiber unidirectional material (UD sheet) or cloth material around the core member, impregnating the fiber unidirectional material or cloth material with a resin material, and then hardening the resulting fiber unidirectional material or cloth material.

5. A method for manufacturing an FRP honeycomb structure according to claim 1 or claim 2, the method being characterized in that the core unit forming step comprises slitting a sheet-like fiber unidirectional material (UD sheet) or cloth material to a desired width to form band-like members, superimposing the band-like members on the outer sides of the core member, impregnating the superimposed band-like members with a resin material, and hardening the resulting band-like members.

6. A method for manufacturing an FRP honeycomb structure according to claim 1 or 2, the method being characterized in that the FRP honeycomb structure is formed by preparing plural types of FRP core units having different braiding yarn types, yarn amounts, yarn thicknesses, braid layer constructions, resin types, or resin amounts, assembling the FRP core units together, and subjecting the FRP core units to a resin material process.

7. A method for manufacturing an FRP honeycomb structure according to claim 1 or 2, the method being characterized in that the honeycomb structure forming step includes a step of coupling together FRP honeycomb structures formed by assembling the FRP core units together so that sides of the FRP honeycomb structures are abutted against one another, to form an FRP honeycomb composite.
